(19) United States
(12) Patent Application Publication
(10) Pub. No.: US 2008/0116288 A1
(43) Pub. Date: May 22, 2008

(54) Duct Damper for Retrofit of Existing Duct

(75) Inventors: Eugene J. Takach, Eden Prairie, MN (US); Bart W. Baxter, Woodbury, MN (US); Paul G. Schwendinger, St. Louis Park, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/561,704

(22) Filed: Nov. 20, 2006

(51) Int. Cl. F24F 7/04; B23P 17/00

(52) U.S. Cl. 236/49.5; 29/469

(57) ABSTRACT

A plurality of duct dampers for use with ducts having a plurality of sizes in an HVAC system having zone control. Each of the plurality of duct dampers has a blade for controlling air flow in a duct, an actuator for controlling the position of the blade within a duct, and a shaft attached to the blade for transmitting the actuator control to the blade. The plurality of dampers includes a plurality of blade sizes to correspond to the plurality of duct sizes. A single shaft length is configured for use with the plurality of blade sizes, where one end of the shaft is positioned on each blade according to the size of the blade.

### FIELD OF THE INVENTION

The invention relates to dampers for controlling the air flow in a duct, and more particularly, to dampers configured to be retrofitted to an existing duct.

### BACKGROUND OF THE INVENTION

Many buildings, particularly relatively small buildings such as single-family houses, have a single heating, ventilation, and air conditioning (HVAC) unit that is controlled by a single thermostat. The HVAC unit typically comprises some type of fluid temperature modifying device, such as a furnace for heating air, a boiler for heating a liquid or steam, or an air conditioner having an evaporating coil for cooling air. If the fluid is air, it is typically ducted to various locations within the building, or if it is liquid or steam, it is typically piped to heat exchangers at various locations in the building. The thermostat in this type of space conditioning system is typically positioned at a location where the heating and cooling loads are representative of the entire structure. For example, the thermostat may be installed in an interior room away from windows and doors that would tend to influence the sensed temperature. The HVAC equipment then controls the heating and cooling of the entire structure according to the thermostat signal received from the single location.

However, a single thermostat location may not accurately represent the heating or cooling needs throughout the structure. Other locations of the building may have significantly greater or lower heating and cooling loads than exist at the location of the thermostat. For example, rooms having a larger surface area of windows, or rooms having exterior walls, may require greater heat inputs to maintain the desired temperature. Similarly, rooms facing south or west, or rooms that are on an upper story, may require greater cooling inputs to maintain the desired temperature. Where the HVAC equipment is controlled only by a single thermostat, the heating or cooling supplied to each individual area of the building will be based on the heating or cooling needs at the thermostat location and not on the actual heating and cooling needs of each individual area. As a consequence, the heating and cooling loads of individual areas of the structure may not be satisfied and the temperature of these areas will tend to deviate from the desired temperature.

In some situations, it may be desired to control different locations within a building at different temperatures. For example, rooms that are seldom occupied may not need to be maintained at the same temperature as rooms that are frequently occupied. Energy that is used to heat or cool these unoccupied rooms is not used effectively or economically. Also, rooms may be occupied by people having special temperature needs, such as an elderly person or an infant, that are preferably maintained at a different temperature than the rest of the building. However, a system that has only a single thermostat is generally unable to accurately control different locations in the building at different temperatures.

One solution to this problem is to utilize HVAC zone control. Rather than having a single thermostat controlling the HVAC equipment, multiple thermostats are positioned at locations within the building that are expected to have different heating and cooling loads. Although it is possible that each of these thermostats could control a separate fluid temperature modifying device such as a separate furnace or air conditioner for each zone, that is generally neither efficient nor economical. Rather, most commonly the ductwork or piping that is used to transmit the conditioned fluid to the building spaces is configured with controls to adjust fluid flow. For example, an air duct may be configured with a controllable damper that is capable of opening and closing to control the flow of air to a space within the building.

A system having HVAC zone control generally requires the use of a zone controller to receive the signals from the various thermostats, control the operation of the heating or cooling device, and control the distribution of the conditioned fluid through the ductwork. The zone controller typically comprises electronic circuitry for evaluating the heating or cooling needs of the various zones of the building and for determining an appropriate control of the heating or cooling device and the dampers or valves that control distribution. The distribution control where the conditioned fluid is air is typically accomplished with a duct damper. A duct damper typically comprises a variable obstruction within the duct that can be actuated to one position where there is relatively little resistance to air flow within the duct, and can be actuated to another position where there is relatively great, or complete, resistance to air flow. Duct dampers can be controlled by any of a number of actuation means, including electronic, pneumatic, or mechanical. The HVAC zone controller generally is configured to open or close a duct damper in order to effectuate control over a zone in response to thermostat signals.

There is a need, however, for improved duct dampers.

### SUMMARY OF THE INVENTION

The invention relates to duct dampers for controlling air flow in air ducts of HVAC systems. A first embodiment of the invention relates to a plurality of HVAC duct dampers that are configured for controlling air flow in ducts having a plurality of different sizes. The plurality of duct dampers includes a first duct damper and a second duct damper. The first duct damper includes a first damper blade that has a first major dimension and that is configured to be installed within a duct that has an interior dimension that is selected to correspond to the first major dimension. The first duct damper also includes a first blade shaft having a first length and having a first end and a second end. The first blade shaft is attached to the first damper blade and forms an axis of rotation of the first damper blade. The first end of the first blade shaft extends beyond a first edge of the damper blade and the second end of the first blade shaft extends to a point between the first edge of the first damper blade and a second edge of the first damper blade, where the second edge is opposite to the first edge. The point to which the first blade shaft extends defines a first shaft mounting distance from the second edge of the first damper blade to the second end of the first blade shaft. The first duct damper also includes a first actuator that is configured to rotate the first blade shaft and first damper blade within the duct to control a flow of air within a duct.

The second duct damper includes a second damper blade having a second major dimension, where the second major dimension is different from the first major dimension. The second damper blade is configured to be installed within a duct that has an interior dimension that is selected to correspond to the second major dimension. The second duct damper also includes a second blade shaft that has the same length as the first blade shaft and also has a first end and a second end. The second blade shaft is attached to the second damper blade and forms an axis of rotation of the second damper blade. The first end of the second blade shaft extends beyond a first edge of the second damper blade and the second end of the blade shaft extends to a point that is between the first edge of the second damper blade and a second edge of the second damper blade, where the second edge is opposite to the first edge. The point that the second blade shaft extends to defines a second shaft mounting distance from the second edge of the second damper blade to the second end of the second blade shaft. The second shaft mounting distance is different from the first shaft mounting distance. The second duct damper also includes a second actuator that is configured to rotate the second blade shaft and second damper blade within the duct to control a flow of air within the duct.

A second embodiment of the invention relates to a method of manufacturing a plurality of duct dampers for use in a plurality of ducts of different sizes. The method includes the step of providing a plurality of damper blades having a range of sizes that are configured to control airflow in a corresponding range of duct sizes, where the range of damper blade sizes includes a maximum blade size and a minimum blade size. The method further includes the step of providing a plurality of damper blade shafts, where each shaft has the same shaft length, the shaft length being at least more than one-half of a major dimension of the maximum blade size, the shaft having a first end and a second end. The method also includes the step of attaching one of the plurality of damper blade shafts to each damper blade to form a plurality of blade shaft and damper blade assemblies and to define an axis of rotation through the center of each damper blade. The attaching step also involves, for each blade shaft and damper blade assembly, configuring the first end of the blade shaft to extend beyond a first edge of the damper blade, and configuring the second end of the blade shaft to extend to a point between the first edge of the damper blade and a second edge of the damper blade that is opposite to the first edge that the first end extends beyond. Furthermore, if the damper blade selected from the plurality of damper blades has the maximum blade size, then the second end of the shaft defines a first distance to the second edge of the damper blade. If the damper blade selected from the plurality of damper blades has the minimum blade size then the second end of the shaft defines a second distance to the second edge of the damper blade. The first distance is greater than the second distance.

Yet another embodiment of the invention relates to a plurality of round HVAC duct dampers configured for controlling air flow in ducts having a plurality of different diameters. The plurality of round duct dampers includes a first duct damper and a second duct damper. The first duct damper includes a first damper blade that has a first diameter. The first damper blade is configured to be installed within a first duct having an interior diameter that is greater than the first diameter. The first duct damper also includes a first blade shaft having a first length and having a first end and a second end. The first blade shaft is attached to the first damper blade and forms an axis of rotation of the first damper blade. The first end of the first blade shaft extends beyond a first edge of the first damper blade, and the second end of the first blade shaft extends to a point between the first edge of the first damper blade and a second edge of the first damper blade that is opposite to the first edge. The point that the first blade shaft extends to defines a first shaft mounting distance from the second edge of the first damper blade to the second end of the first blade shaft. The first duct damper also includes a first actuator that is configured to rotate the first blade shaft and first damper blade within the duct to control a flow of air within a duct.

The second duct damper includes a second damper blade that has a second diameter, where the second diameter is different from the first diameter. The second damper blade is configured to be installed within a second duct that has an interior diameter that is greater than the second diameter. The second duct damper also includes a second blade shaft having the same length as the first blade shaft and having a first end and a second end. The second blade shaft attaches to the second damper blade and forms an axis of rotation of the second damper blade. The first end of the second blade shaft extends beyond a first edge of the second damper blade and the second end of the blade shaft extends to a point between the first edge of the second damper blade and a second edge of the second damper blade that is opposite to the first edge. The point that the second blade shaft extends beyond defines a second shaft mounting distance from the second edge of the second damper blade to the second end of the second blade shaft. The second shaft mounting distance is different from the first shaft mounting distance. The second duct damper also includes a second actuator that is configured to rotate the second blade shaft and second damper blade within the duct to control a flow of air within the duct.

The invention may be more completely understood by considering the detailed description of various embodiments of the invention that follows in connection with the accompanying drawings.

### BRIEF DESCRIPTION OF THE DRAWINGS

FIG. 1 is a schematic of an HVAC system having multiple zones (prior art).

FIG. 2 is a perspective view of a damper assembly and a duct section configured to receive a damper assembly.

FIG. 3 is a side view of a damper assembly.

FIG. 4 is an alternative perspective view of a damper assembly.

FIG. 5 is a side view of a plurality of damper assemblies forming a damper assembly product line.

FIG. 6 is a cross-sectional view of a damper assembly.

FIG. 7 is a side view of a plurality of damper assemblies having rectangular damper blades forming a damper assembly product line.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

### DETAILED DESCRIPTION OF THE INVENTION

A zone control system requires that certain components be installed in an HVAC system in order to function properly. In some cases, zone control system components are installed when the building and/or HVAC system is originally constructed. However, in other cases the building or HVAC system is constructed first and only later does the building owner or occupant decide to install a zone control system. In this case, it is necessary to retrofit the existing HVAC system with zone control components.

However, retrofitting an existing HVAC system with zone control components can be challenging. One particular difficulty is associated with installing the dampers required for the operation of a zone control system within the existing ductwork. In many cases, the air supply ductwork forms an integral part of the building structure, such that the building structure surrounds the ductwork or there is very little clearance between the ductwork and other building components. Also, the ductwork is not readily disassembled to introduce a new piece part into the ductwork. Therefore, it is preferred that a damper for retrofitting an existing HVAC system be configured to be readily installed into a duct where limited access space is available and to be installed in a manner that does not require the disassembly or rework of the existing duct work. In addition, many different sizes and configurations of ductwork are typically used in HVAC systems, often in common sizes such as round duct that is 5 inches, 6 inches, 7 inches, and 8 inches in diameter. It is thus desired that a damper be available to retrofit into any size or configuration of duct that may be commonly found in the existing HVAC system. Furthermore, the decision by a building owner or occupant to install a zone control system is typically cost-sensitive. Therefore, it is also desired that a damper for retrofit use be cost-effective.

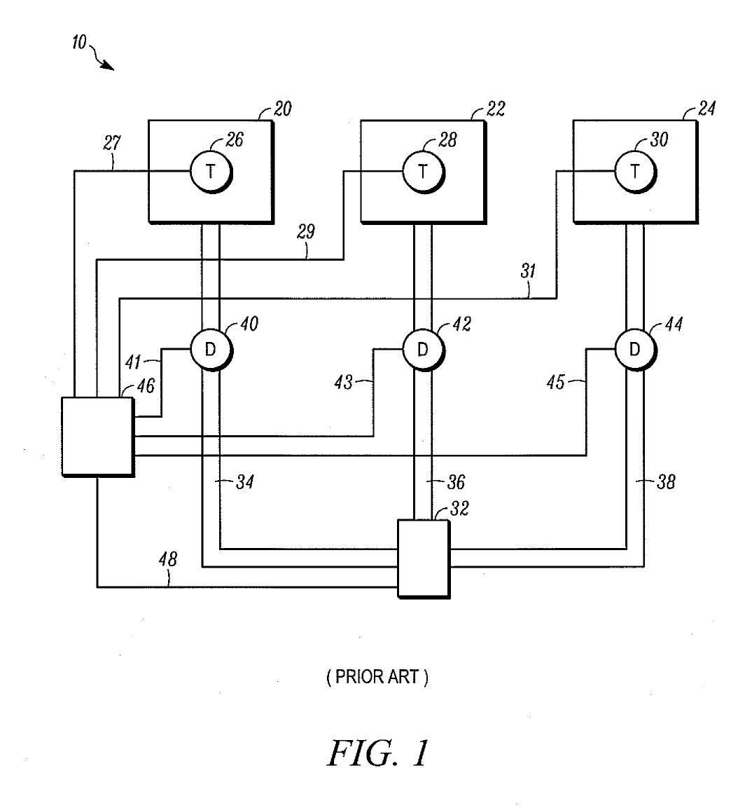

FIG. 1 is a schematic of a typical HVAC system 10 having multiple zones. The embodiment of FIG. 1 is shown as having three zones. However, other embodiments having fewer or greater numbers of zones are usable. Zones 20, 22, 24 are separate areas of a building. Each zone 20, 22, 24 includes a thermostat 26, 28, 30, respectively. A conditioning unit 32 is provided for increasing or decreasing the temperature of a fluid. For example, conditioning unit 32 may be a furnace that increases the temperature of air. In the case where conditioning unit 32 is a furnace, heated air is transmitted through ducts 34, 36, 38 to each of zones 20, 22, 24, respectively. Each duct 34, 36, 38 includes a damper 40, 42, 44, respectively, for controlling the flow of air through ducts 34, 36, 38. Zone controller 46 is configured to receive signals from each of thermostats 26, 28, 30, through cables 27, 29, 31, respectively. Zone controller 46 is also configured to transmit control signals to each of dampers 40, 42, 44, through cables 41, 43, 45. Zone controller 46 is further configured to transmit control signals to conditioning unit 32 through cable 48.

A variety of control strategies for zone controller 46 are usable. In general, however, zone controller 46 is configured to open and close dampers 40, 42, 44, in response to signals from thermostats 26, 28, 30, respectively, and to operate conditioning unit 32. For example, if zone controller 46 senses that thermostat 26 is calling for heat because the temperature in zone 20 has fallen below a preset level, then zone controller 46 sends a signal to conditioning unit 32 to turn on and signals damper 40 to be in an open position. Heated air from conditioning unit 32 will then travel through duct 34, through damper 40, and into zone 20, thereby tending to increase the temperature within zone 20. If at the same time thermostats 28, 30 in zones 22, 24 do not call for heat, dampers 42, 44 will be closed and heated air will not travel through ducts 36, 38 into zones 22, 24. The operation of HVAC system 10 in response to other thermostat signals from other zones and other combinations of zones is similar. HVAC system 10 may include other sensing devices and other sources of input to zone controller 46, as well as other actuating devices and other devices that are controlled by zone controller 46.

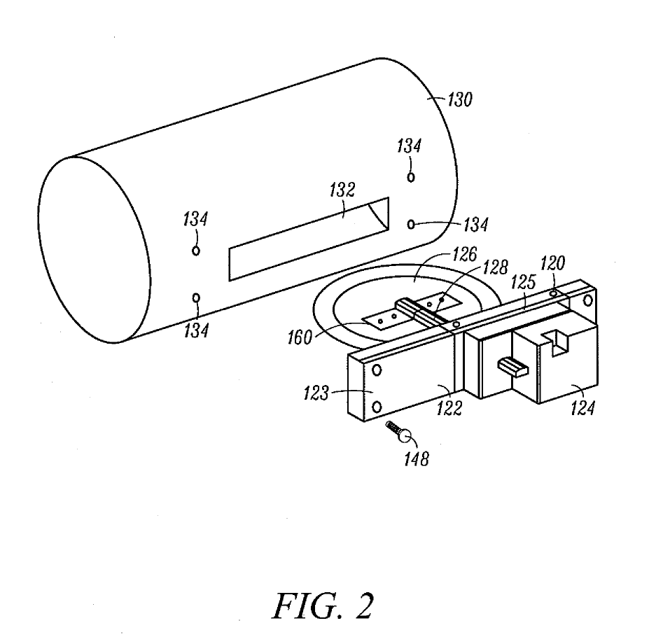

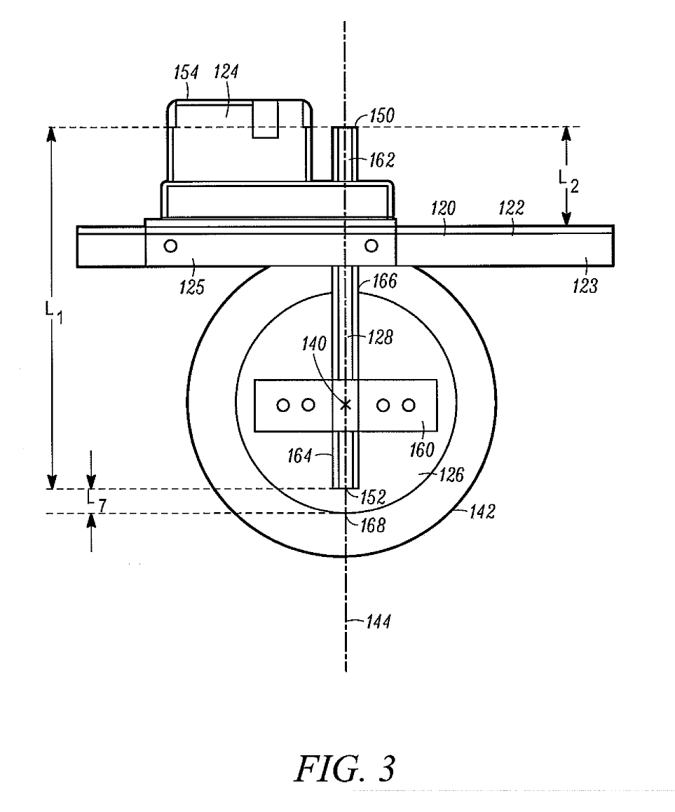

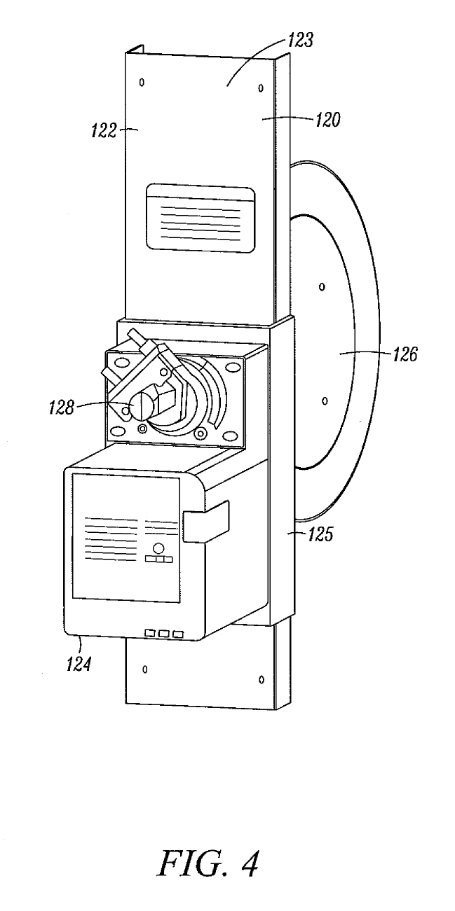

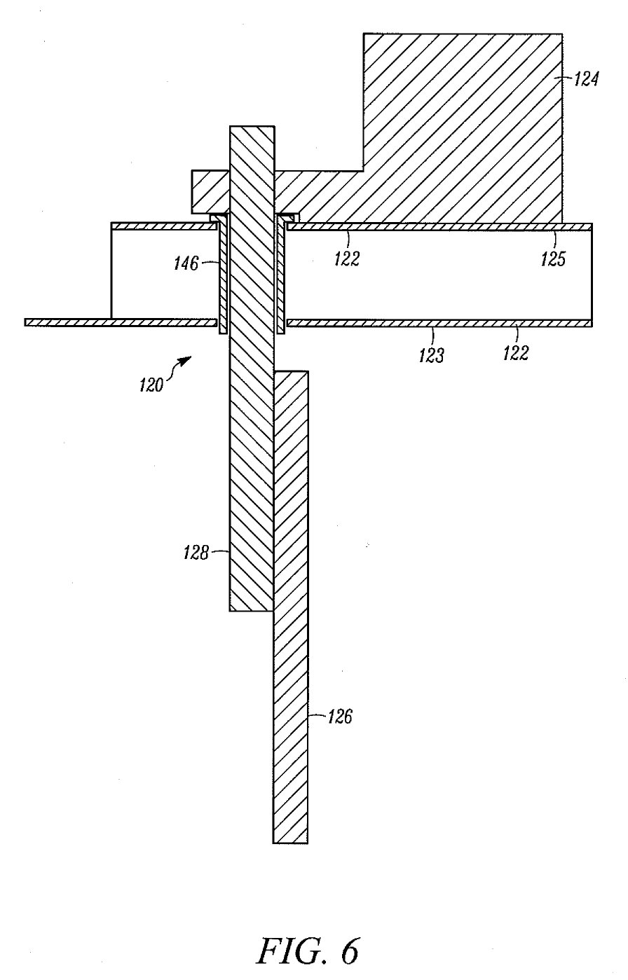

An embodiment of a damper configured for installation in a duct is shown in perspective view in FIG. 2. Damper assembly 120 generally includes a frame 122 configured for attachment to a duct, a damper blade 126 configured to control airflow in a duct, and a damper blade shaft 128 configured for attachment to damper blade 126, and an actuator 124 configured to cause rotation of damper blade shaft 128. Damper assembly 120 is also shown in FIG. 3 in a side view and in FIG. 4 in a different perspective view. Many embodiments of damper blade shaft 128 are usable. In one embodiment, damper blade shaft 128 has a hexagonal cross section. Damper blade shaft 128 is attached to damper blade 126, such that damper blade shaft 128 forms an axis of rotation 144 generally through an approximate center 140 of damper blade 126. In the embodiment of FIGS. 2 and 3, damper blade shaft 128 is attached to damper blade 126 through strap 160. However, many other usable embodiments exist for attaching damper blade shaft 128 to damper blade 126, such as fasteners, brackets, welding, etc. Damper blade shaft 128 passes through frame 122 to engage with actuator 124, or alternatively engages with actuator 124 through a mechanism, in such a way that actuator 124 can control the rotational position of damper blade shaft 128 and damper blade 126 with respect to frame 122. At the location where damper blade shaft 128 passes through frame 122 and other associated components, a bushing 146 is used to provide a rotational bearing area and support. Bushing 146 is shown in the cross-sectional view of damper assembly 120 in FIG. 6. Bushing 146 extends generally through frame 122. As shown in FIGS. 3 and 6, one embodiment of the frame 122 includes two parts. The frame 122 includes a mounting bracket 123, which is attached to the duct wall, and a saddle 125, which is attached to the mounting bracket 123 and the actuator 124. In one embodiment, the bushing passes through both the mounting bracket 123 and the saddle 125.

Damper blade 126 is configured to control air flow in a duct having a certain cross-sectional profile. For example, where a duct is generally round, damper blade 126 will be generally round, or where a duct is generally rectangular, damper blade 126 will be generally rectangular. Damper blade 126 is generally planar in shape, so that its thickness is significantly less than its height and width or diameter. The height and width or diameter of damper blade 126 are examples of major dimensions of the damper blade 126. Damper blade 126 generally has a major dimension that is sized to correspond to the duct sizing, such that the major dimension of the damper blade 126 is slightly smaller than an interior dimension of the duct. For example, in one embodiment the major dimension of damper blade 126 is about 1.625 inches smaller than an interior dimension of the duct. In another embodiment, the major dimension of damper blade 126 is 1.5 inches to 1.75 inches less than an interior dimension of the duct. The major dimension of damper blade 126 corresponds to a dimension that is useful for controlling the air flow in a duct.

For example, in cases where round ducts are provided having standard inner diameters of 5 inches, 6 inches, 7 inches, and 8 inches, corresponding damper blades 126 are provided that each have a major dimension that is a diameter that corresponds to the duct diameter by being slightly less than the duct diameters. For the standard inner duct diameters of 5 inches, 6 inches, 7 inches, and 8 inches, exemplary corresponding damper blade diameters are 3.375 inches, 4.375 inches, 5.375 inches and 6.375 inches, respectively.

Alternatively, damper blade 126 may also be configured for use in a range of standard rectangular duct sizes, such as 6 inches tall×8 inches wide, 6 inches tall×10 inches wide, 10 inches tall×12 inches wide, 12 inches tall×20 inches wide, and 16 inches tall×30 inches wide. In this case, damper blade 126 has major dimensions of width and height that are sized to correspond to the duct sizing, such as the height or width of the duct. For example, for the standard inner duct dimensions of 6×8 inches and 6×10 inches, exemplary corresponding damper blade dimensions are 4.375×6.375 inches, and 4.375×8.375 inches, respectively.

In one embodiment, damper blade 126 further includes a gasket 142 around the outer edge of damper blade 126 that is configured to create a seal with an interior duct wall when damper assembly 120 is installed in a duct and damper blade 126 is in a closed position. Damper blade 126 is generally configured to correspond to the duct sizing by being slightly smaller than the nominal dimensions of the duct, so that the inherent variability in duct dimensions as well as the potential for ducts to flex or bow under pressure or gravity will not cause the damper blade to bind or not turn within the duct. One example of an appropriate material for the damper blade is two layers of 20 gauge sheet metal. Gasket 142 is constructed from a flexible material that extends beyond the edges of damper blade 126 and is configured to seal a gap formed between the damper blade 126 and duct 130. In one embodiment, gasket 142 is attached to damper blade 126 by having at least a portion that is sandwiched between two layers used to form damper blade 126.

Duct 130 is shown in FIG. 2 as a section of generally round duct. Other duct configurations are usable, such as square or rectangular duct sections. Duct 130 is generally modified by the installer to have an insertion opening 132 and, optionally, a plurality of fastener openings 134. Insertion opening 132 is configured to allow the damper blade 126 to be inserted into duct 130, and accordingly, insertion opening 132 has a long dimension that is at least equal to the diameter of the duct and a short dimension that is sufficient to at least provide clearance to the thickness of the damper blade 126.

In operation, damper assembly 120 is assembled to duct 130 and attached thereto by a plurality of fasteners 148 that engage duct 130. Many other types of attachment are usable, however, such as adhesives, welding, rivets, etc. In one embodiment, one or more wires are attached to actuator 124 that provide for the transmission of electrical signals from a controller, such as zone controller 46. Alternatively, other forms of control of actuator 124 may be utilized, such as pneumatic control through tubing or mechanical control through linkages, as well as wireless signals. Zone controller 46 (shown in FIG. 1), or other controller, provides control signals to actuator 124 that control the position of damper blade 126 within duct 130. For example, where zone controller 46 intends to provide air flow to a zone of a building, zone controller will signal actuator 124 in a manner that causes damper blade 126 to be open. Actuator 124 will cause damper blade shaft 128 and damper blade 126 to rotate as necessary so that damper blade 126 is positioned in a plane approximately parallel to the axis or direction of airflow of duct 130. In other words, damper blade 126 will be placed in an open position so that air can flow with minimal restriction through duct 130. Alternatively, at other times zone controller 46 may intend to prevent air flow to a zone of a building. In this case, zone controller will initiate a signal to actuator 124 to close damper blade 126. Actuator 124 will cause damper blade shaft 128 and damper blade 126 to rotate as necessary so that damper blade 126 is positioned in a plane approximately perpendicular to the axis of the duct 130. In other words, damper blade 126 will be placed in a closed position so that air can not flow through duct 130, or that there is such a large resistance to flow that very little air flows through duct 130. In this way, zone controller 46 can control the air flow within a duct, and consequently, can control the conditioning of a zone within a building.

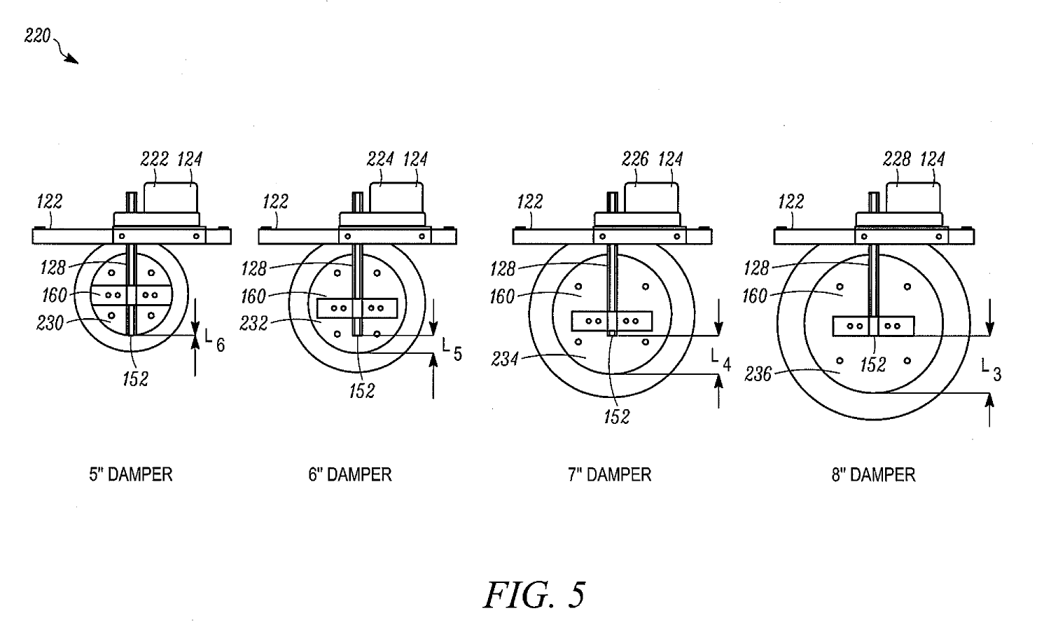

As discussed, damper assembly 120 is preferably provided in a number of different sizes or configurations to function with ducts having a number of different sizes or configurations. For example, round ducts may be provided having standard inner diameters such as 5 inches, 6 inches, 7 inches, and 8 inches, and it is desired to have a corresponding plurality of damper assemblies 120 having different damper blade diameters for each duct diameter. Such a plurality of damper assemblies may comprise a damper assembly product line 220, as shown in FIG. 5. For example, damper assembly product line 220 may include a first damper assembly 222 configured for a 5 inch round duct, a second damper assembly 224 configured for a 6 inch duct, a third damper assembly 226 configured for a 7 inch duct, and a fourth damper assembly 228 configured for a 8 inch duct. Other duct size configurations and number of damper assemblies in a damper assembly product line 220 are usable.

Each damper assembly 222, 224, 226, 228 of damper assembly product line 220 preferably utilizes as many components as possible that are common with each of the other damper assemblies 222, 224, 226, 228. Having common components promotes ease of assembly of the damper assembly product line and reduces manufacturing piece part and inventory costs. For example, each damper assembly 222, 224, 226, 228 is configured to utilize the same frame 122 and actuator 124. By necessity, each damper assembly 222, 224, 226, 228 will utilize a different damper blade that corresponds to the intended duct size that it will be used with. For example, damper assembly 222 uses a damper blade 230 that is configured for a 5 inch duct, damper assembly 224 uses a damper blade 232 that is configured for a 6 inch duct, damper assembly 226 uses a damper blade 234 that is configured for a 7 inch duct, and damper assembly 228 uses a damper blade 236 that is configured for a 8 inch duct. Generally, the range of damper blade diameters of damper assembly product line 220 includes a maximum blade diameter and a minimum blade diameter corresponding to a maximum and minimum duct diameter that the product line 220 is configured for use with.

However, despite the fact that damper assembly product line 220 includes a variety of different damper blade sizes, in one embodiment, each damper assembly 222, 224, 226, 228 of damper assembly product line 220 uses a common damper blade shaft 128. As is seen more clearly in FIG. 3, damper blade shaft 128 has a first end 150 and a second end 152, and is characterized by a length L₁. In one embodiment, length L₁ of damper blade shaft 128 is at least more than one-half of the maximum blade diameter. The damper blade shafts 128 have identical lengths L₁, yet are able to be used with differently sized damper blades.

In each damper assembly 222, 224, 226, 228, damper shaft 128 is attached to the respective damper blade 230, 232, 234, 236 through an approximate center of each damper blade to define an axis of rotation of the damper blade. As shown in FIG. 3 (and is similar for damper blades 230, 232, 234, 236 of damper assemblies 222, 224, 226, 228), the first end 150 of damper shaft 128 extends beyond a first edge 166 of damper blade 126 and passes through the frame 122 and into engagement with actuator 124. Damper shaft 128 includes an actuator part 162 and a blade part 164, which together make up the entire length of the damper shaft 128. An end of actuator part 162 defines first end 150, and an end of blade part 164 defines second end 152. The actuator part 162 defines a length L₂ from the first end 150 to frame 122. It is preferred that L₂ be less than the distance from the frame 122 to the top 154 of actuator 124, so as not to interfere with other components or building structures that may be near the damper assembly 230, 232, 234, 236. In one embodiment, the length L₂ of the actuator part 162 of the damper shaft is the same for the various damper assemblies 222, 224, 226, 228, as can be seen in FIG. 5.

The blade part 164 of damper shaft 128 extends from the frame 122 to the second end 152. In the embodiment of FIG. 3, second end 152 is located at a point between the first edge 166 that the first end 150 extends beyond and a second edge 168 of the damper blade opposite to the first edge 166 that the first end 150 extends beyond. As such, the distance between second end 152 and second edge 168 is characterized as distance L₇. Because the length L₁ of damper shaft 128 is constant, and because the length L₂ that the shaft 128 extends above frame 122 is also constant, the distance L₇ between second end 152 and edge 168 of blade 126 will vary according to the diameter of blade 126. For example, if the damper blade 126 has the maximum blade diameter (such as damper assembly 228 in FIG. 5), then the second end 152 of the shaft 128 defines a distance to the edge of blade 236 that is designated in FIG. 5 as L₃. Likewise, if the damper blade has the minimum blade diameter (such as damper assembly 222), then the second end 152 of the shaft 128 defines a distance to the edge of blade 230 that is designated in FIG. 5 as L₆. Furthermore, for damper blades having intermediate blade diameters (such as damper assemblies 224, 226), then the second end 152 of the shaft 128 defines a distance to the edge of blades 232, 234 that is designated in FIG. 5 as L₅, L₄, respectively. Generally, for a range of diameters of damper blade 126, the distance that second end 152 defines to the edge of the blade will be largest for the largest blade diameter and will be smallest for the smallest blade diameter. Accordingly, distance L₆ will be smaller than distance L₅, and distance L₅ will be smaller than distance L₄, and so forth.

Furthermore, the range of possible blade 126 diameters for use with constant length shaft 128 is limited by the need to prevent the second end 152 of shaft 128 from extending past the far edge 168 of blade 126. Given the constraints that the length L₁ of shaft 128 is constant and that the length L₂ that shaft 128 extends beyond frame 122 is constant, there is only a limited range of blade 128 diameters within product line 220 that are usable. Alternatively, where conditions permit, the distance L₂ can be allowed to vary, so that a longer shaft 128 can be used and a larger range of damper blade 126 diameters are usable.

A product line duct dampers may be configured, for example, for use with a plurality of round ducts having various sizes such as inner diameters of 5 inches, 6 inches, 7 inches, and 8 inches. In one embodiment of such a product line, the blade shaft length L₁ is 5.5 to 9 inches. In another embodiment, the blade shaft length L₁ is 7.0 to 7.5 inches.

It is preferred that blade 126 and blade shaft 128 be configured to have sufficient strength to resist excessive flexing when in the closed position in a pressurized duct. When blade 126 is in a closed position in a duct, there will be a relatively higher pressure on one side of blade 126 and a relatively lower pressure on the opposite side of blade 126. This pressure differential will create a force that acts on the blade 126, where the force is equal to the area of the blade multiplied by the pressure differential. Both damper blade 126 and damper shaft 128 contribute to resisting this force. However, a particular concern exists with respect to configurations where damper shaft 128 does not extend across the full width of damper blade 126, such as in dampers 224, 226, 228 having larger blade diameters. These dampers also have larger blade diameters, and therefore have larger forces to resist. Each of the damper blades, such as 230, 232, 234, 236, and damper shaft 128, should be configured with sufficient strength to resist these forces, such as through sufficient thickness of damper blade 230, 232, 234, 236 and sufficient cross-sectional area of shaft 128.

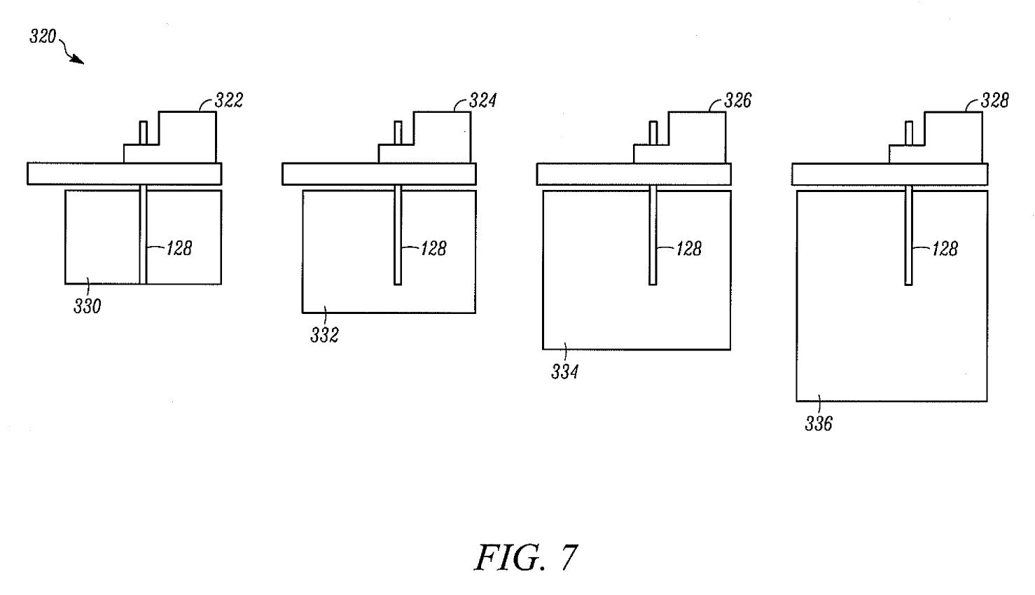

As discussed above, a damper assembly product line may also be configured for use with rectangular ducts. For example, FIG. 7 shows damper assembly product line 320 configured for use with rectangular or square ducts. Product line 320 includes damper assemblies 322, 324, 326, 328, where each damper assembly 322, 324, 326, 328 is configured for a different size rectangular or square duct. Damper assemblies 322, 324, 326, 328 are constructed similarly to damper assemblies 222, 224, 226, 228, except that damper blades 330, 332, 334, 336 are rectangular or square instead of being round. Each damper assembly 322, 324, 326, 328 uses the same damper shaft 128 regardless of damper blade size.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

The above specification provides a complete description of the structure and use of the invention. Since many of the embodiments of the invention can be made without parting from the spirit and scope of the invention, the invention resides in the claims.

What is claimed is:

1. A plurality of HVAC duct dampers configured for controlling air flow in ducts having a plurality of different sizes, the plurality of duct dampers comprising:
(i) a first duct damper, the first duct damper comprising
(a) a first damper blade having a first major dimension, the first damper blade configured to be installed within a duct having an interior dimension selected to correspond to the first major dimension;
(b) a first blade shaft having a first length and having a first end and a second end, the first blade shaft attached to the first damper blade and forming an axis of rotation of the first damper blade, the first end of the first blade shaft extending beyond a first edge of the first damper blade and the second end of the first blade shaft extending to a point between the first edge of the first damper blade and a second edge of the first damper blade that is opposite to the first edge, the point defining a first shaft mounting distance from the second edge of the first damper blade to the second end of the first blade shaft; and
(c) a first actuator configured to rotate the first blade shaft and first damper blade within the duct to control a flow of air within a duct; and
(ii) a second duct damper, the second duct damper comprising
(a) a second damper blade having a second major dimension, where the second major dimension is different from the first major dimension, the second damper blade configured to be installed within a duct having an interior dimension selected to correspond to the second major dimension;
(b) a second blade shaft having the first length and having a first end and a second end, the second blade shaft attached to the second damper blade and forming an axis of rotation of the second damper blade, the first end of the second blade shaft extending beyond a first edge of the second damper blade and the second end of the blade shaft extending to a point between the first edge of the second damper blade and a second edge of the second damper blade that is opposite to the first edge, the point defining a second shaft mounting distance from the second edge of the second damper blade to the second end of the second blade shaft, where the second shaft mounting distance is different from the first shaft mounting distance; and
(c) a second actuator configured to rotate the second blade shaft and second damper blade within the duct to control a flow of air within the duct.

2. The plurality of HVAC duct dampers of claim 1, wherein the dampers are configured for installation in round ducts, and
(i) the first damper blade is generally round and the first major dimension is a diameter of the first damper blade; and
(ii) the second damper blade is generally round and the second major dimension is a diameter of the second damper blade.

3. The plurality of HVAC duct dampers of claim 1, wherein the dampers are configured for installation in rectangular ducts, and
(i) the first damper blade is generally rectangular and the first major dimension is a width of the first damper blade; and
(ii) the second damper blade is generally rectangular and the second major dimension is a width of the second damper blade.

4. The plurality of HVAC duct dampers of claim 3, wherein the width of the first damper blade is larger than a height of the first damper blade, and the width of the second damper blade is larger than a height of the second damper blade.

5. The plurality of HVAC duct dampers of claim 1, wherein each actuator is configured to receive a signal from a zone controller and to control a flow of air in a duct in response to the signal.

6. The plurality of HVAC duct dampers of claim 1, wherein the first and second duct dampers each further comprise a frame configured for attachment to an exterior surface of a duct, each frame having an opening to provide clearance to each blade shaft.

7. The plurality of HVAC duct dampers of claim 6, wherein each frame further comprises a bushing for receiving each blade shaft, where each bushing passes through each frame.

8. A method of manufacturing a plurality of duct dampers for use in a plurality of ducts of different sizes, the method comprising the steps of:
(i) providing a plurality of damper blades having a range of sizes that are configured to control airflow in a corresponding range of duct sizes, the range of damper blade sizes including a maximum blade size and a minimum blade size;
(ii) providing a plurality of damper blade shafts, where each shaft has the same shaft length, the shaft length being at least more than one-half of a major dimension of the maximum blade size, the shaft having a first end and a second end; and
(iii) attaching one of the plurality of damper blade shafts to each damper blade to form a plurality of blade shaft and damper blade assemblies and to define an axis of rotation through the center of each damper blade, where for each blade shaft and damper blade assembly:
(a) the first end of the blade shaft extends beyond a first edge of the damper blade;
(b) the second end of the blade shaft extends to a point between the first edge of the damper blade and a second edge of the damper blade that is opposite to the first edge that the first end extends beyond; and
(iv) wherein if a damper blade selected from the plurality of damper blades has the maximum blade size, then the second end of the shaft defines a first distance to the second edge of the damper blade, and
(v) wherein if a damper blade selected from the plurality of damper blades has the minimum blade size then the second end of the shaft defines a second distance to the second edge of the damper blade, and the first distance is greater than the second distance.

9. The method of manufacturing a plurality of duct dampers of claim 8, wherein the step of providing a plurality of damper blades comprises providing a plurality of round damper blades having a plurality of diameters that are configured to control airflow in a plurality of round ducts having a plurality of duct diameters, where the maximum blade size, minimum blade size and major dimension are diameters.

10. The method of manufacturing a plurality of duct dampers of claim 8, wherein the step of providing a plurality of damper blades comprises providing a plurality of rectangular damper blades having a plurality of widths that are configured to control airflow in a plurality of rectangular ducts having a plurality of duct widths, where the maximum blade size and minimum blade size are widths.

11. The method of manufacturing a plurality of dampers of claim 8, wherein, for each damper blade, the width is larger than a height.

12. The method of manufacturing a plurality of duct dampers of claim 8, the method further comprising the step of providing a plurality of frames configured for attachment to exterior surfaces of a duct, the frames each having an opening to provide clearance to each blade shaft, and the step of assembling each damper blade shaft through the opening in the frame.

13. The method of manufacturing a plurality of duct dampers of claim 12, the method further comprising the steps of providing a plurality of bushings, assembling each bushing to each frame through the opening, and assembling each blade shaft through each bushing.

14. A plurality of round HVAC duct dampers configured for controlling air flow in ducts having a plurality of different diameters, the plurality of duct dampers comprising:
(i) a first duct damper, the first duct damper comprising
(a) a first damper blade having a first diameter, the first damper blade configured to be installed within a first duct having an interior diameter greater than the first diameter;
(b) a first blade shaft having a first length and having a first end and a second end, the first blade shaft attached to the first damper blade and forming an axis of rotation of the first damper blade, the first end of the first blade shaft extending beyond a first edge of the first damper blade and the second end of the first blade shaft extending to a point between the first edge of the first damper blade and a second edge of the first damper blade that is opposite to the first edge, the point defining a first shaft mounting distance from the second edge of the first damper blade to the second end of the first blade shaft; and
(c) a first actuator configured to rotate the first blade shaft and first damper blade within the duct to control a flow of air within a duct; and
(ii) a second duct damper, the second duct damper comprising
(a) a second damper blade having a second diameter, where the second diameter is different from the first diameter, the second damper blade configured to be installed within a second duct having an interior diameter greater than the second diameter;
(b) a second blade shaft having the first length and having a first end and a second end, the second blade shaft attached to the second damper blade and forming an axis of rotation of the second damper blade, the first end of the second blade shaft extending beyond a first edge of the second damper blade and the second end of the blade shaft extending to a point between the first edge of the second damper blade and a second edge of the second damper blade that is opposite to the first edge, the point defining a second shaft mounting distance from the second edge of the second damper blade to the second end of the second blade shaft, where the second shaft mounting distance is different from the first shaft mounting distance; and
(c) a second actuator configured to rotate the second blade shaft and second damper blade within the duct to control a flow of air within the duct.

15. The plurality of HVAC duct dampers of claim 14, wherein each actuator is configured to receive a signal from a zone controller and to control a flow of air in a duct in response to the signal.

16. The plurality of HVAC duct dampers of claim 14, wherein the first and second duct dampers each further comprise a frame configured for attachment to an exterior surface of a duct, each frame having an opening to provide clearance to each blade shaft.

17. The plurality of HVAC duct dampers of claim 16, wherein each frame further comprises a bushing for receiving each blade shaft, where each bushing passes through each frame.
